(19) United States
(12) Patent Application Publication
(10) Pub. No.: US 2004/0013434 A1
(43) Pub. Date: Jan. 22, 2004

(54) Wireless data processing system and method

(76) Inventor: Yu-Cheng Hua, Taipei Hsien (TW)

Correspondence Address: SHAW PITTMAN, IP GROUP, 1650 TYSONS BOULEVARD, SUITE 1300, MCLEAN, VA, 22102, US

(21) Appl. No.: 10/119,727

(22) Filed: Apr. 11, 2002

(30) Foreign Application Priority Data
Apr. 16, 2001 (TW) 090108999

(51) Int. Cl. G05B 15/00

(52) U.S. Cl. 398/106; 700/83; 345/156

(57) ABSTRACT

A wireless data processing system and method, adapted to a computer system having an infrared device, enables a user to wirelessly operate the computer system by a remote control. For example, during a multimedia presentation a current slide shown on a display will be changed to the next slide when a user presses the “Page Down” key on the remote control. That is, the computer system performs the corresponding process according to the signal emitted from the remote control and received by the infrared device. The invention comprises a mode switching module for switching an infrared controller of the infrared device between the FIR mode and the ASK mode.

### BACKGROUND OF THE INVENTION

1. Field of the Invention

The present invention relates to an art of operating a computer system, and more particularly, to a wireless data processing system and method adapted to a computer system having an infrared device. According to the present invention, a user can wirelessly operate the computer system by a remote control, and the computer can perform the corresponding process according to the signal emitted from the remote control and received by the infrared device.

2. Description of the Prior Art

A computer system, such as a laptop computer, a desktop computer, or a PDA (Personal Digital Assistant), is typically equipped with a keyboard, a mouse, or a digital plate, as an input device. When a speaker makes a multimedia presentation using a computer with the professional presentation software and a projector, the speaker often needs to control a keyboard or a mouse to change between different slides or to perform other multimedia functions. Accordingly, he has to keep himself near the computer and can not walk around freely as he desires during the presentation. Otherwise, he may have to ask an assistant to operate the computer for him. Both of the ways mentioned above are inconvenient can not satisfy the speaker to give a smooth speech.

Many computer systems, such as portable computers, are provided with infrared device for wireless communication with another computer system, a PDA, or a mobile phone. At present, there are technologies to wirelessly operate a computer system by an infrared remote control. It enables a speaker to remotely operate a computer system with a remote control so that the speaker can give a presentation more smoothly.

A computer system comprising an infrared device usually has an infrared controller built in a chipset for processing the infrared signals. A typical infrared controller built in a chipset has an FIR mode for supporting wide bandwidth processing and an ASK mode for supporting narrow bandwidth processing. The FIR mode and the ASK mode are not compatible to each other and can not be applied at the same time. In most operation systems, such as the popular operating system Windows, the FIR mode is chosen for wireless communication between two computers, or between a computer and an apparatus. However, comparing to the remote control with an ASK mode, a remote control with an FIR mode is more expensive. Moreover, as a data transferring device, the remote control with the FIR mode which possessing wide bandwidth processing ability is not necessary, because such a wide bandwidth will not be fully utilized, and such is a waste of bandwidth.

Accordingly, people need a new technology of wireless communication so that one can use a remote control with an ASK mode to wirelessly operate a computer under the Windows, and need not to worry about the conflict between the FIR mode and the ASK mode.

### SUMMARY OF THE INVENTION

It is therefore a primary object of the present invention to provide a novel wireless data processing system and method that can extend the function of an infrared device without changing the hardware structure of a computer system with an infrared device.

Another object of the present invention is to provide a wireless data processing system and method that enables a user wirelessly and remotely to operate the computer system.

One more object of the present invention is to provide a wireless data processing system and method that enables a speaker to remotely operate a computer without using a keyboard or a mouse for changing between slides in a multimedia presentation.

For the objects mentioned above, the present invention provides a novel wireless data processing system and method that enables a user to wirelessly and remotely operate a computer system comprising an infrared device by a remote control.

The wireless data processing system according to the present invention comprises: (a) a mode switching module for switching the infrared controller from FIR mode to the ASK mode so as to enable a user to operate a computer system having an infrared device by a remote control with ASK mode; and (b) a key simulation module for analyzing the corresponding signal emitted from the remote device and received by the infrared device, and for instructing the computer to perform the process represented by the corresponding signal.

When operating a computer system comprising an infrared device by a remote control with an ASK mode, at first, a user inputs through a keyboard or a mouse a signal confirming the use of the remote control with an ASK mode, so as to instruct the computer system to start the mode switching module to switch the infrared device from the FIR mode to the ASK mode. Next, the user begins to operate the remote control with ASK mode, and the computer system analyzes and identifies the signal sent from the remote control. The key simulation module then enables the computer system to perform the process represented by the corresponding signal.

The computer system mentioned above may be any intelligent information system, such as a laptop computer, a desktop computer, a PDA, or a digital camera, wherein the data is transferred between the computer system and the remote control using infrared signals, such that a user is able to wirelessly and remotely operate the computer system. For example, when a user gives a presentation by using a laptop computer, he does not need to use a keyboard or a mouse to change between slides. Instead, by using the wireless data processing system and method according to the present invention, the user can change slides by a remote control so as to make the presentation more smoothly.

Moreover, according to the wireless data processing system of the present invention, a user can operate a computer system not only by a remote control, but also by a wireless keyboard, a wireless mouse, or other one-way or two-way wireless apparatus.

It is an advantage of the present invention that without any change of hardware structure, the ASK mode infrared remote control, which has simple structure and is low cost, can be used on a computer system operated under an operation system which supports only the FIR mode.

The foregoing and other objects, features and advantages of the present invention will be apparent from the following detailed description of a preferred embodiment of the invention as illustrated in the accompanying figures.

### BRIEF DESCRIPTION OF THE DRAWINGS

FIG. 1 is a block diagram showing the structure of the wireless data processing system according to the present invention;

FIG. 2 is a block diagram of the main control module in FIG. 1;

FIG. 3 is a flow chart showing the fundamental operation steps of the wireless data processing method according to the present invention; and

FIG. 4 is a flow chart for illustrating the operation of the step S5 in FIG. 3.

### DETAILED DESCRIPTION OF THE PREFERED EMBODIMENT

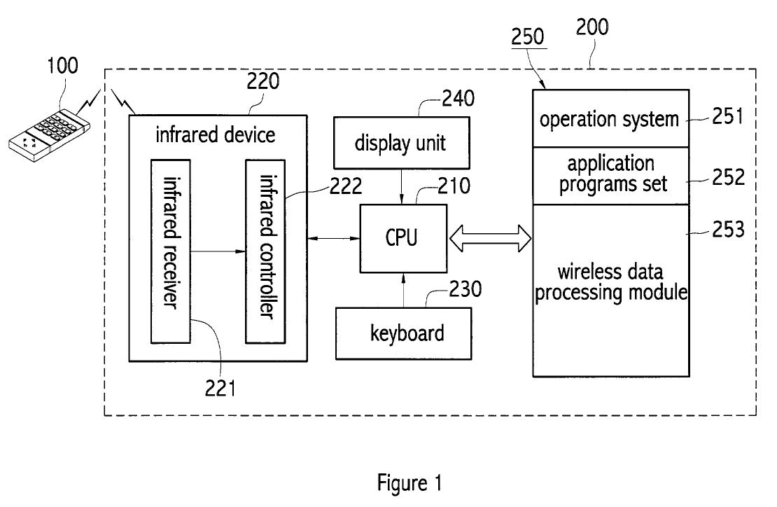

Please refer to FIG. 1, which is a block diagram showing the structure of the wireless data processing system according to the present invention. It illustrates the fundamental system structure of a computer system 200 accompanying with a remote control 100. The computer system 200 comprises a central processing unit (CPU) 210, an infrared device 220, a keyboard 230, a display unit 240, and a memory unit 250. In order to simplify the drawings and description, only the elements relate to the present invention are illustrated herewith.

The remote control 100 comprises an infrared emitter (not shown) with an ASK mode. The remote control 100 further has a plurality of keys on its panel, and a track ball (not shown) may be also installed thereon. The remote control 100 is well known, and hence will not be described in detail herein. The computer system 200 may be a laptop computer, a desktop computer, a PDA, a digital camera, or any other intelligent information system, with at least an infrared device 220 installed therein.

The CPU 210 is employed to execute the programs stored in the memory unit 250 and is also a well known data processing device, hence its function and internal structure will not be described in detail. The infrared device 220 mainly comprises an infrared receiver 221 and an infrared controller 222. The infrared controller 222 has the function of an FIR mode and an ASK mode and is also a well known device and will not be described in detail. The user can use the remote control 100 to communicate with the infrared device 220 with the ASK mode, and thus can operate the computer system 200 wirelessly and remotely. The keyboard 230 is employed to input commands by users so as to instruct the CPU 210 to access the memory unit 250 and execute the programs stored in the memory unit 250. The display unit 240 is employed to display the interface and the execution status of the programs, which are stored in the memory unit 250 and executed by the CPU 210.

The memory unit 250 can be any memory, such as a ROM (Read Only Memory), a RAM (Random Access Memory), etc., which allows the CPU 210 to access and execute the programs and data stored therein when the computer system 200 is in operation. The data and programs include an operation system 251, the application programs set 252, and the wireless data processing module 253 which is employed to start the performing of the wireless data processing method according to the present invention.

The operation system 251 is employed to control the operation of the computer system 200, and is required to any computer system 200. The operation system 251 may be the Windows 95, the Windows 98, the Windows 2000, etc. It is a well known system to those skilled in the computer technology and will not be described in detail hereinafter.

The application programs set 252 includes all kinds of application programs such as the software developed by Microsoft; for example, the Power Point for presentation, the Word for word processing, etc.

The wireless data processing module 253 is the program written for the method according to the present invention. The program can call the function library of the operation system 251 and instruct the operation system 251 to close the infrared controller 222, such that the users can operate the computer system wirelessly and remotely by using the remote control 100.

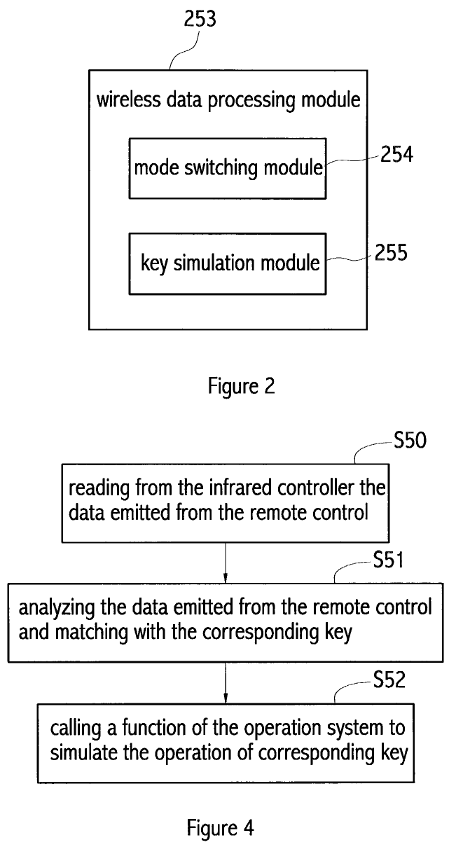

Please refer to FIG. 2, which is a block diagram of the wireless data processing module 253 as shown in FIG. 1. The wireless data processing module 253 comprises a mode switching module 254 and a key simulation module 255. The mode switching module 254 is employed to switch the infrared controller 222 between the FIR mode and the ASK mode. The key simulation module 255 is employed to match the signal, which is emitted from the ASK remote control 100 and received by the infrared device 220, with a key of the computer system 200, and to simulate the operation of the corresponding key on the computer system 200.

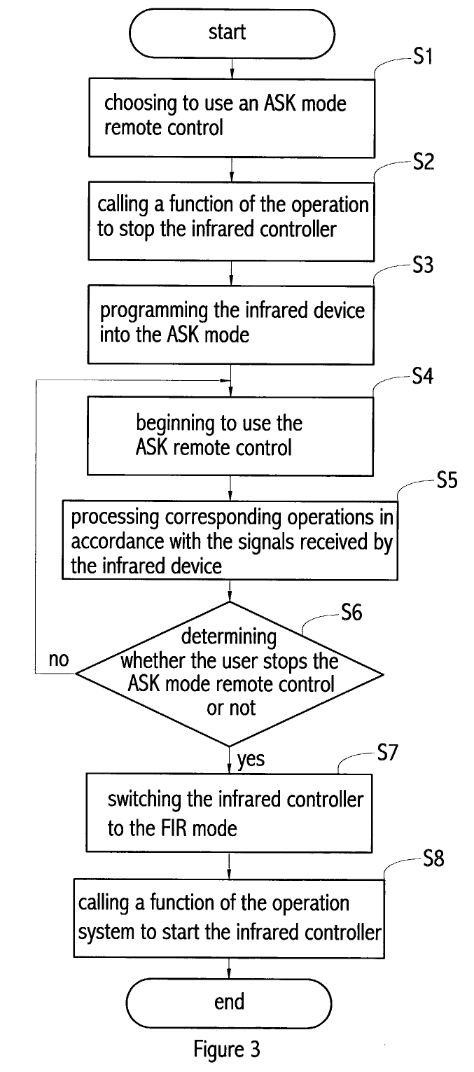

Please refer to the FIG. 3, which is a flow chart showing the operation of the wireless data processing method according to the present invention. Please refer to both FIG. 1 and FIG. 3. At the first step S1, a user chooses to use an ASK mode remote control 100 and inputs a signal to the CPU 210 by using the keyboard 230 or a mouse, so as to confirm the use of the remote control 100.

At the second step S2, after the CPU 210 receives from the keyboard 230 or a mouse the signal confirming the use of the remote control 100 ,the mode switching module 254 calls a function of the operation system 251, instructing the operation system 251 to stop the infrared controller 222. For example, the module 254 calls the function of DiChangeState ( ) under the Windows 98, or the function of SetupDiCallClassInstaller ( ) under the Windows 2000 to complete this step. Thereafter, the operation system 251 will release the control right of controlling the infrared controller 222.

At the third step S3, the mode switching module 254 further performs an initialization operation to program the infrared device 220 into the ASK mode. After the step S2 and the step S3, the infrared device 220 is eventually switched from the FIR mode to the ASK mode and the control right of controlling the infrared controller 222 is transferred from the operation system to the wireless data processing module 253.

At the fourth step S4, the user begins to use the ASK remote control 100. The user presses a certain button (not shown) on the panel of the remote control 100, and then the corresponding infrared signal is emitted to the infrared device 220 of the computer system 200.

At the fifth step S5, the infrared device 220 receives the infrared signal emitted from the remote control 100, and the key simulation module 255 responds to the infrared signal. A more detail illustration for this response is shown in FIG. 4. At the step S50, the key simulation module 255 reads from the infrared controller 222 the infrared signal emitted from the remote control 100. At the step S51, the key simulation module 255 analyzes the infrared signal emitted from the remote control 100 and matches with the key on the keyboard which corresponds thereto, and then transfers the received digital signal to the code which represents the key. At the step S52, the key simulating module 255 calls a function of the operation system 251 to simulate the operation of the corresponding key on the computer system 200. For example, under the operation system of Windows, the module 255 calls the function keybd₁₃ event ( ) to store the code in the buffer for being accessed by the application programs. For example, during the multimedia presentation by using the software PowerPoint, the current slide shown on the display unit 240 will be changed to the next slide when the speaker presses the “Page Down” key (not shown) on the panel of remote control 100.

At the sixth step S6, it is determined whether the user stop the ASK remote control 100 or not. If not, the step S4 and the step S5 are repeated so that the user can wirelessly and remotely operate the computer system 200 simply and freely. If the user inputs from a keyboard 230 or a mouse a signal indicating to stop the use of the remote control 100, then it goes to the step S7.

At the seventh step S7, the CPU 210 receives the signal confirming to stop the use of the ASK remote control 100, and accordingly the key simulation module 255 is stopped. Further, the mode switching module 254 will switch the infrared device 220 from the ASK mode to the FIR mode.

At the eighth step S8, the mode switching module 254 calls a function of the operation system 251, i.e., the function DiChangeState ( ) in the Windows 98 or the function SetupDiCallClassInstaller ( ) in the Windows 2000, to instruct the operation system 251 to start the infrared controller 222.

According to the present invention, the ASK mode infrared remote control can be used in a computer system having an infrared device, and operated under an operation system which supports only the FIR mode without any change of hardware structure. Such an ASK mode remote control has the advantage of simple structure and low cost.

The preferred embodiments described above are to be considered in all respects as illustrative and not restrictive. For example, the signal confirming the use of the remote control 100 inputted to the CPU is not limited to be inputted from only a keyboard, but may also be inputted from any input device such as a mouse. Moreover, the remote control 100 is not limited to be installed with a plurality of keys for simulating the keys on a keyboard, and a track ball may be installed thereon for simulating the operation of a mouse. Furthermore, the wireless data processing system and method according to the present invention are not limited to be wirelessly or remotely applied only to a computer system during a presentation or a speech, it may also be applied to operate a computer system wirelessly and remotely. For example, one may install an infrared transceiver on a keyboard, a mouse, or any other remote control device which transfers data in one-way or two-way, so as to communicate with a computer system wirelessly and remotely. The above disclosure should be construed as limited by the metes and bounds of the claims described below, and all modifications which come within the meaning and range of equivalency of the claims are therefore intended to be embraced therein.

What is claimed is:

1. A wireless data processing system adapted to a computer system having an infrared device, the infrared device comprising an infrared receiver and an infrared controller having an FIR mode and an ASK mode, for communication with a remote device having an infrared emitter, said wireless data processing system comprising:
a mode switching module for switching the infrared controller between the FIR mode and the ASK mode; and
a key simulation module for matching a signal, which is emitted from the remote device and received by the infrared device, with a key of the computer system and for simulating an operation of the corresponding key on the computer system.

2. The wireless data processing system as claimed in claim 1, wherein the infrared controller is built in a chipset.

3. The wireless data processing system as claimed in claim 1, wherein the remote device is an infrared remote control.

4. The wireless data processing system as claimed in claim 1, wherein the remote device is an infrared wireless keyboard.

5. The wireless data processing system as claimed in claim 1, wherein the remote device is an infrared wireless mouse.

6. The wireless data processing system as claimed in claim 1, wherein the infrared device further comprises an infrared emitter and the remote device further comprises an infrared receiver.

7. The wireless data processing system as claimed in claim 1, wherein the remote device further comprises a track ball.

8. The wireless data processing system as claimed in claim 1, wherein the computer system is a laptop computer.

9. The wireless data processing system as claimed in claim 1, wherein the computer system is a desktop computer.

10. A wireless data processing method adapted to a computer system having an infrared device, the infrared device comprising an infrared receiver and an infrared controller having an FIR mode and an ASK mode, for communication with a remote device having an infrared emitter, said computer system is installed with an operating system, said wireless data processing method comprising the steps of:
switching the infrared controller between the FIR mode and the ASK mode in accordance with an instruction of a user;
matching a signal, which is emitted from the remote device and received by the infrared device, with a key of the computer system; and
simulating an operation of the corresponding key on the computer system.

11. The wireless data processing method as claimed in claim 10, wherein the step of switching the infrared controller between the FIR mode and the ASK mode further comprises the step of switching the infrared controller from the FIR mode to the ASK mode, and the step of switching the infrared controller from the ASK mode to the FIR mode.

12. The wireless data processing method as claimed in claim 11, wherein the step of switching the infrared controller from the FIR mode to the ASK mode further comprises the steps of:
calling the operating system to stop the infrared device; and
programming the infrared device to the ASK mode.

13. The wireless data processing method as claimed in claim 11, wherein the step of switching the infrared controller from the ASK mode to the FIR mode further comprises the steps of:
programming the infrared device to the FIR mode; and
calling the operating system to start the infrared device.

14. The wireless data processing method as claimed in claim 10, wherein the infrared controller is built in a chipset.

15. The wireless data processing method as claimed in claim 10, wherein the remote device is an infrared remote control.

16. The wireless data processing method as claimed in claim 10, wherein the remote device is an infrared wireless keyboard.

17. The wireless data processing method as claimed in claim 10, wherein the remote device is an infrared wireless mouse.

18. The wireless data processing method as claimed in claim 10, wherein the infrared device further comprises an infrared emitter and the remote device further comprises an infrared receiver.

19. The wireless data processing method as claimed in claim 10, wherein the remote device further comprises a track ball.

20. The wireless data processing method as claimed in claim 10, wherein the computer system is a laptop computer.

21. The wireless data processing method as claimed in claim 10, wherein the computer system is a desktop computer.

22. The wireless data processing method as claimed in claim 10, wherein the key matched with the signal is a “Page Down” or a “Page Up” key.

23. A computer readable recording medium recorded with a computer program adapted to be used in computer system having an infrared device, the infrared device comprising an infrared receiver and an infrared controller having an FIR mode and an ASK mode, for communication with a remote device having an infrared emitter; said computer program enables the computer system to execute the steps of:
switching the infrared controller between the FIR mode and the ASK mode in accordance with an instruction of a user;
matching a signal, which is emitted from the remote device and received by the infrared device, with a key of the computer system; and
simulating the operation of the corresponding key on the computer system.

24. The computer readable recording media claimed in claim 23, wherein the step of switching the infrared controller between the FIR mode and the ASK mode further comprises the step of switching the infrared controller from the FIR mode to the ASK mode, and the step of switching the infrared controller from the ASK mode to the FIR mode.

25. The computer readable recording media as claimed in claim 24, wherein the step of switching the infrared controller from the FIR mode to the ASK mode further comprises the steps of:
calling the operating system to stop the infrared device; and
programming the infrared device to the ASK mode.

26. The computer readable recording media as claimed in claim 24, wherein the step of switching the infrared controller from the ASK mode to the FIR mode further comprises the steps of:
programming the infrared device to the FIR mode; and
calling the operating system to start the infrared device.
